(19) United States
(12) Patent Application Publication
(10) Pub. No.: US 2006/0203912 A1
(43) Pub. Date: Sep. 14, 2006

(54) Motion vector detection method, motion vector detection apparatus, computer program for executing motion vector detection process on computer

(76) Inventor: Tomoya Kodama, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/230,509

(22) Filed: Sep. 21, 2005

(30) Foreign Application Priority Data
Mar. 14, 2005 (JP) P.2005-071448

(51) Int. Cl. H04N 11/02; H04N 7/12; H04B 1/66; H04N 11/04

(52) U.S. Cl. 375/240.16

(57) ABSTRACT

A motion vector detection method includes: a first obtaining unit that obtains similarities of images near a plurality of initial search points with an image of a partial region of a current frame; a setting unit that sets a plurality of subsequent search point candidates based on a gradient of the similarities obtained at the plurality of initial search points respectively; a second obtaining unit that obtains similarities of images near the plurality of search point candidates set thus with the image of the partial region of the current frame; and a detection unit that detects a motion vector for the image of the partial region of the current frame based on a position of one of the plurality of search point candidates providing highest similarity of the similarities obtained for the plurality of search point candidates respectively.

### RELATED APPLICATIONS

The present disclosure relates to the subject matter contained in Japanese Patent Application No. 2005-071448 filed on Mar. 14, 2005, which is incorporated herein by reference in its entirety.

### BACKGROUND OF The INVENTION

1. Field of the Invention

The present invention relates to a motion vector detection required for performing motion-compensated prediction encoding upon moving pictures such as MPEG-2 (Moving Picture Expert Group phase 2) or MPEG-4 (Moving Picture Expert Group phase 4).

2. Description of the Related Art

In a moving picture encoding process for purposes of accumulation and transmission of picture, such as MPEG-2, compression is attained by cutting down the information volume of moving pictures by use of a correlation between picture frames. Here, as for detection of a motion vector following the motion of each partial image between temporally sequential frame images, a partial image (block image) comprised of a plurality of pixels in a current image is an object to be processed, and the position where the block to be processed exists in a precedingly coded image with respect to the current image (the position of a coded image to which the image of the block to be processed is the most similar) is examined by a so-called block matching method. Thus, a motion vector indicating the motion direction and the motion quantity of the image is detected.

This motion vector detection process occupies a very high ratio in throughput with respect to the moving picture compression encoding process as a whole. As a solution to this problem, there is a motion vector detection method based on a steepest-descent method, such as a method in which a recursive gradient method, that is, a method of estimating a motion vector from a relation between a spatial gradient of a pixel signal and an inter-frame difference thereof is executed until convergence so as to obtain a high-precision motion vector, or a method using a diamond search in which a motion vector minimizing an inter-frame difference is obtained sequentially in accordance with a search pattern for obtaining a rough motion vector, and a motion vector is then obtained in accordance with a search pattern for obtaining a fine motion vector. It has been suggested that the amount of required computing can be reduced on a large scale according to these methods as compared with a full search method which is the simplest motion vector search method. It has been known that the amount of computing can be more saved particularly when a point having the highest likelihood score as a motion vector is set as an initial search point prior to application of the steepest-descent method.

In order to further cut down the search process during the motion vector detection, hierarchization to obtain a motion with subpixel precision is generally used in the motion vector search after the step of obtaining a motion vector with integer precision.

Here, when the initial search point is obtained with high precision, it is possible to shorten the time when the steepest-descent method is applied in the time of processing for the motion vector search. However, there is a problem that the time taken for the motion vector search with subpixel precision in the subsequent step is elicited.

The diamond search disclosed in a Non-Patent Document 1, which is specified below, is a method for searching an integer-precision pixel motion vector. On the other hand, in an international standard system such as MPEG-1/-2/-4 or MPEG-4 AVC/H.264 (Advanced Video Coding/H.264), the motion vector precision is half pixel or quarter pixel. Particularly in half-pixel precision motion vector search in some profiles of MPEG-4 or in MPEG-4 AVC/H.264, a 6-tap FIR filter (Finite Impulse Response filter) is used for interpolating interpixel values with high precision. Therefore, when full search around the integer-precision motion vector obtained by the diamond search is performed with subpixel precision, the throughput required for detection increases to be an obstacle to attainment of real time encoding by software. In addition, in hardware, there is a problem that the full search causes increase in power consumption, memory bandwidth or circuit scale due to the motion vector search process.

On the other hand, according to the method of improved diamond search as disclosed in a Non-Patent Document 2, which is specified below, detection of an integer-precision pixel motion vector can be achieved in less computing amount. According to this method, detailed search is performed around a best primary search point after two-pixel precision motion vector search (primary search), so as to perform one-pixel precision motion vector search (secondary search). It is considered that the motion vector can be detected by less computing amount in this method, because that the search pattern used when detecting rough movement in the primary search is less dense with respect to the aforementioned diamond search.

However, in order to execute motion vector detection while securing search precision, it is necessary to secure at least eight points as candidates in the detailed search (secondary search) after the primary search. Thus, the motion vector is detected in the detailed search by repeating a block matching process around each candidate eight times, whereas in the diamond search, the motion vector is detected in the detailed search by repeating the block matching process around each candidate four times. Accordingly, there is a problem that the throughput for the detailed search (secondary search) in the motion vector search cannot be saved, and the time of processing cannot be shortened in many images.

Non-Patent Document 1: S. Zhu and K. K. Ma, “A new diamond search algorithm for fast block matching motion estimation,” IEEE Trans. on Image Processing, vol. 9, no. 2, pp. 287-290, February 2000

Non-Patent Document 2: K. Ramkishor, PSSBK Gupta, et al., “Algorithmic Optimization for Software-Only MPEG-2 Encoding,” IEEE Trans. on Consumer Electronics, Vol. 50, No. 1, February 2004

### SUMMARY OF The INVENTION

As described above in detail, in any background-art motion vector detection method, it is intended to save the overall throughput by hierarchization of a motion vector search range. However, the number of search point candidates in detailed search (secondary search) cannot be narrowed. Accordingly, there is a problem that the throughput for the secondary search cannot be saved, and the time of processing cannot be shortened.

According to a first aspect of the invention, there is provided a motion vector detection method for detecting a motion vector indicating a displacement of a part of an image of a reference frame to an image of a partial region of a current frame, the method including: obtaining similarities of images near a plurality of initial search points with the image of the partial region of the current frame, the initial search points being set on the reference frame; setting a plurality of subsequent search point candidates based on either one of: (1) a gradient of the similarities obtained for the plurality of initial search points respectively; or (2) a distribution of the similarities obtained for the plurality of initial search points respectively; obtaining similarities of images near the set plurality of search point candidates with the image of the partial region of the current frame; and detecting a motion vector for the image of the partial region of the current frame based on a position of one of the plurality of search point candidates providing highest similarity of the similarities obtained for the plurality of search point candidates respectively.

According to a second aspect of the invention, there is provided a motion vector detection apparatus that detects a motion vector indicating a displacement of a part of an image of a reference frame to an image of a partial region of a current frame, the reference frame being temporally continuous with the current frame, the motion vector detection apparatus including: a first obtaining unit that obtains similarities of images near a plurality of initial search points with the image of the partial region of the current frame, the initial search points being set on the reference frame; a setting unit that sets a plurality of subsequent search point candidates based on either one of: (1) a gradient of the similarities obtained for the plurality of initial search points respectively; or (2) a distribution of the similarities obtained for the plurality of initial search points respectively; a second obtaining unit that obtains similarities of images near the set plurality of search point candidates with the image of the partial region of the current frame; and a detecting unit that detects a motion vector for the image of the partial region of the current frame based on a position of one of the plurality of search point candidates providing highest similarity of the similarities obtained for the plurality of search point candidates respectively.

According to a third aspect of the invention, there is provided a computer-readable program product for causing a computer system to execute procedures for detecting a motion vector indicating a displacement of a part of an image of a reference frame to an image of a partial region of a current frame, the reference frame being temporally continuous with the current frame, the procedures including: obtaining similarities of images near a plurality of initial search points with the image of the partial region of the current frame, the initial search points being set on the reference frame; setting a plurality of subsequent search point candidates based on either one of: (1) a gradient of the similarities obtained for the plurality of initial search points respectively; or (2) a distribution of the similarities obtained for the plurality of initial search points respectively; obtaining similarities of images near the set plurality of search point candidates with the image of the partial region of the current frame; and detecting a motion vector for the image of the partial region of the current frame based on a position of one of the plurality of search point candidates providing highest similarity of the similarities obtained for the plurality of search point candidates respectively.

### BRIEF DESCRIPTION OF The DRAWINGS

In the accompanying drawings:

FIG. 1 is a diagram showing the overall configuration of a moving picture encoding apparatus according to an embodiment of the present invention;

FIG. 2 is a flow chart showing a first embodiment of a motion vector detection method according to the invention;

FIG. 3 is a diagram showing a motion vector search pattern in Short LDSP;

FIG. 4 is a flow chart showing rough vector search based on a steepest-descent method using Short LDSP;

FIG. 5 is a table showing an example of update of SADs;

FIG. 6 is a diagram showing an example of setting of one-pixel precision motion vector search points using the motion vector detection method according to the invention;

FIG. 7 is a diagram showing an example of program code for motion vector search (SAD calculation);

FIG. 8 is a diagram showing an example of transition of search points according to the invention;

FIG. 9 is a flow chart showing a second embodiment of the motion vector detection method according to the invention; and

FIG. 10 is a diagram showing an example of setting of half-pixel precision motion vector search points using the motion vector detection method according to the invention.

### DETAILED DESCRIPTION OF The PREFERRED EMBODIMENTS

Referring now to the accompanying drawings, a description will be given in detail of embodiments of the invention.

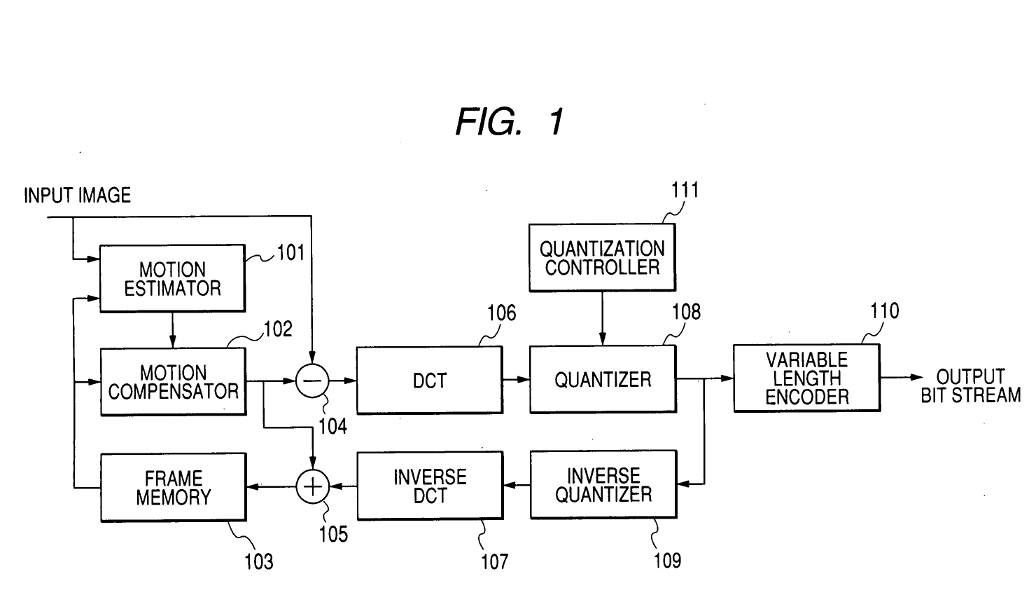

FIG. 1 shows an example of a block diagram of the whole of MPEG encoding apparatus to which the method and apparatus for detecting a motion vector according to the invention can be applied. The MPEG encoding apparatus includes: a motion estimator 101; a motion compensator 102; a frame memory 103; a subtracter 104; an adder 105; a discrete cosine transformer (DCT) 106; an inverse discrete cosine transformer (inverse DCT) 107; a quantizer 108; an inverse quantizer 109; a variable-length encoder 110; and a quantization controller 111.

An image encoded in the past is subjected to inverse quantization and inverse DCT in the inverse quantizer 109 and the inverse DCT 107, and accumulated in the frame memory 103. When an image to be encoded newly is input, the motion compensator 102 detects a motion vector indicating which part of the image accumulated in the frame memory 103 an image of a partial region (macroblock) of the input image has been moved from. An estimated image for the image to be encoded newly is generated from the motion vector detected by the motion estimator 101 and the image accumulated in the frame memory. Error information between the estimated image and the input image is transformed into a DCT coefficient (106), processed by quantization (108), encoded with variable length coding (110), and output as a compression-encoded sequence (output bit stream).

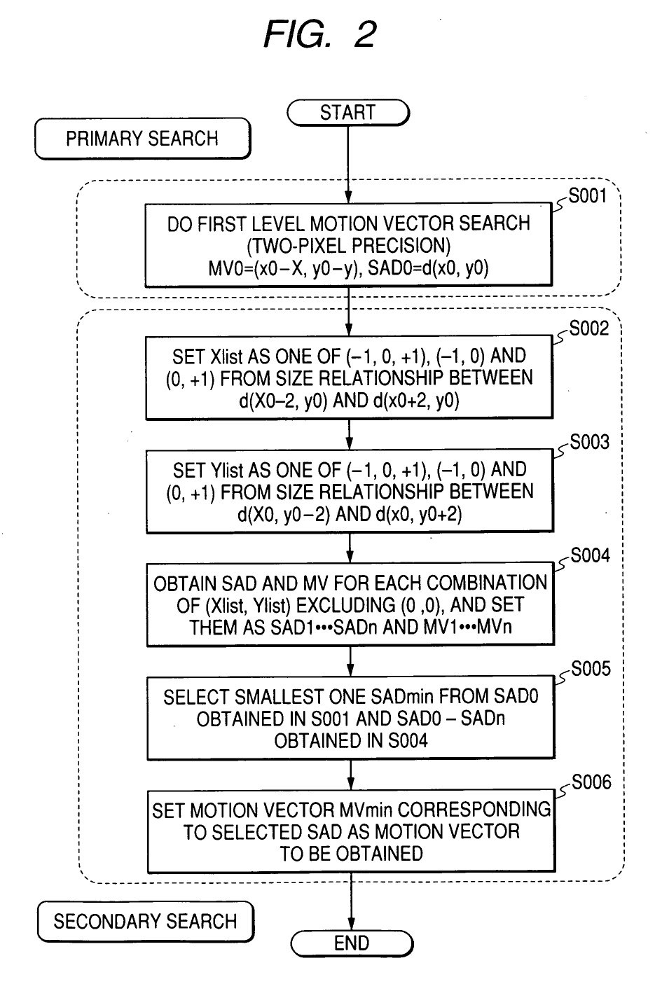

Next, detailed description will be made about the method and apparatus for detecting a motion vector, which method and apparatus are used in the aforementioned motion estimator 101. FIG. 2 is a flow chart showing the method for detecting a motion vector according to a first embodiment of the invention. The processing routine of FIG. 2 is roughly classified into a process for detecting a motion vector with rough precision (primary search: S001) and a process for detecting a motion vector with fine precision in accordance with the result of the primary search (secondary search: S002 and the following steps). An object of this embodiment is to obtain an integer-precision motion vector finally by the two levels of motion vector searches.

In the embodiment, the motion estimator 101 serves as: a first obtaining unit that obtains similarities of images near a plurality of initial search points with the image of the partial region of the current frame, the initial search points being set on the reference frame; a setting unit that sets a plurality of subsequent search point candidates based on either one of: (1) a gradient of the similarities obtained for the plurality of initial search points respectively; or (2) a distribution of the similarities obtained for the plurality of initial search points respectively; a second obtaining unit that obtains similarities of images near the set plurality of search point candidates with the image of the partial region of the current frame; and a detecting unit that detects a motion vector for the image of the partial region of the current frame based on a position of one of the plurality of search point candidates providing highest similarity of the similarities obtained for the plurality of search point candidates respectively.

Assume that a method called Short LDSP (Short Large Diamond Search Pattern) as disclosed in Non-Patent Document 2 is used as an algorithm of the primary search (first level motion vector search) for obtaining a motion vector in Step S001. Incidentally, the invention is applicable not only to Short LDSP but also directly to diamond search and to other hierarchical search methods.

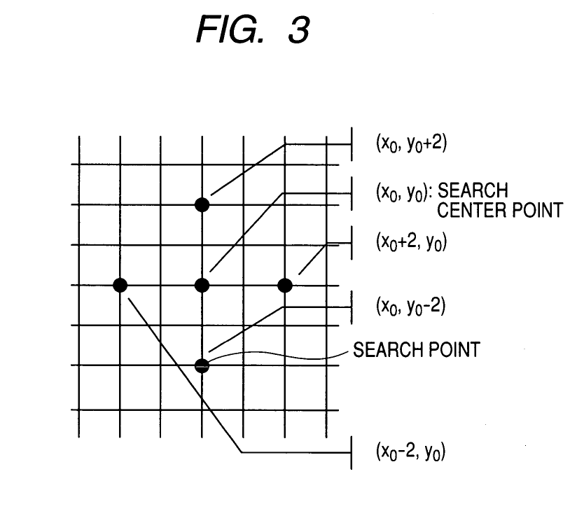

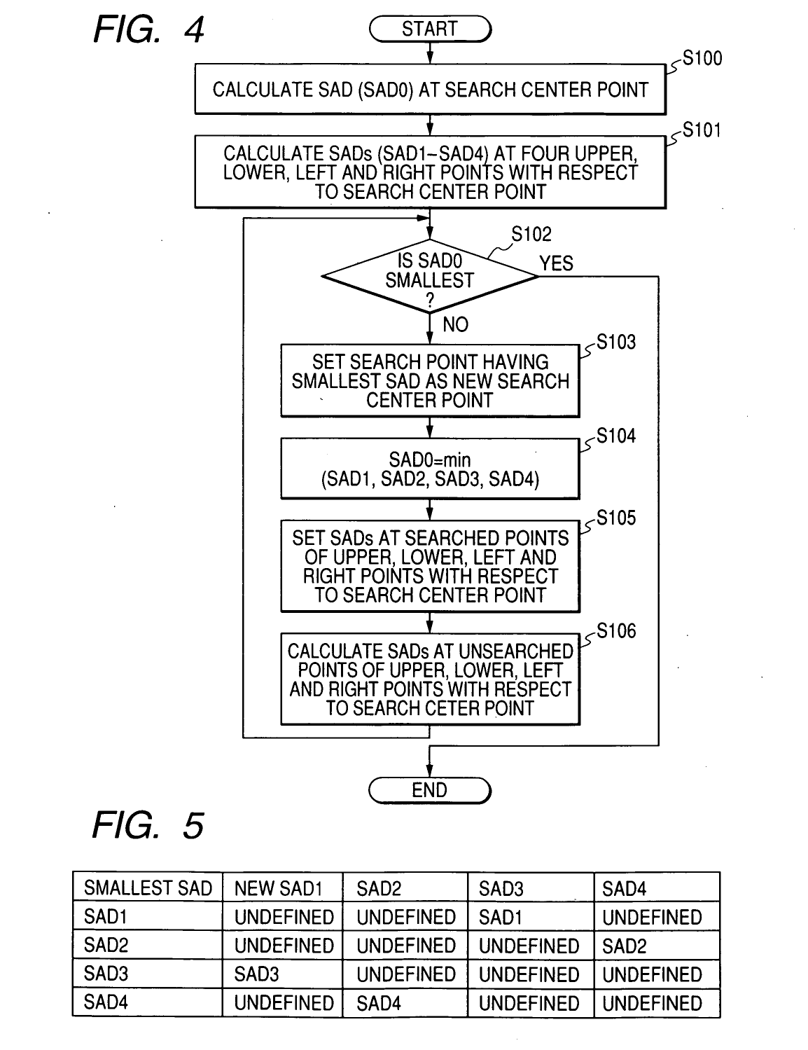

FIG. 3 shows initial search points for the motion vector search using Short LDSP. In Step S001, a rough-precision motion vector is obtained based on the steepest-descent method using each search point of Short LDSP shown in FIG. 3. This flow chart is shown in FIG. 4.

First, in Step S100, block matching is performed between a search center point r(x₀, y₀)εR set on a reference image R and a macroblock (rectangular region comprised of 16×16 pixels) located at a point c(x, y)εC on a current encoded image C. Thus, an SAD (Sum of Absolute Differences) indicating the similarity between the search center point and the current macroblock is obtained by the following expression.

$$\begin{matrix}SAD 0 = D ( {x}_{0} , {y}_{0} ) \\ = {\sum }_{i = 0}^{15} {\sum }_{j = 0}^{15} \vert r ( {x}_{0} + j , {y}_{0} + i ) - c ( x + j , y + i ) \vert\end{matrix} \qquad [ Expression 1 ]$$

A small value of an SAD indicates that the difference between a search point and a current macroblock is so small that the search point is similar to the current macroblock (the value of similarity is large). On the contrary, a large value of a SAD indicates that a search point is not similar to a current macroblock (the value of similarity is small). That is, it can be said that when two search points different in SAD with respect to one and the same macroblock are compared with each other, the search point providing an SAD of a smaller value is a search point which is smaller in difference from the current macroblock and expresses a better motion vector.

Incidentally, a method for obtaining not SAD but SSD (Sum of Squared Differences) may be used. The block matching process in the invention is not limited to SAD. In addition, in the description of this embodiment, matching is evaluated by the concept of “similarity (degree of similarity)” between an image to be encoded and a reference image. However, an evaluation function to obtain a search point providing a small cost value may be defined by evaluating the case of a small degree of similarity between the images as “large in cost value (large in information amount required for encoding)”.

In Step S101, SADs are obtained for upper, lower, left and right points (x₀, y₀+2), (x₀, y₀−2), (x₀−2, y₀) and (x₀+2, y₀) respectively centering at the point (x₀, y₀) in the same manner as in Expression 1. When the SADs for these points are referred to as SAD1, SAD2, SAD3 and SAD4, the SADs can be obtained by the following expressions.

$$SAD 1 = {\sum }_{i = 0}^{15} {\sum }_{j = 0}^{15} \vert \begin{matrix}r ( {x}_{0} + 2 + j , {y}_{0} + i ) - \\ c ( x + j , y + i )\end{matrix} \vert \\ SAD 2 = {\sum }_{i = 0}^{15} {\sum }_{j = 0}^{15} \vert \begin{matrix}r ( {x}_{0} + j , {y}_{0} + 2 + i ) - \\ c ( x + j , y + i )\end{matrix} \vert \\ SAD 3 = {\sum }_{i = 0}^{15} {\sum }_{j = 0}^{15} \vert \begin{matrix}r ( {x}_{0} - 2 + j , {y}_{0} + i ) - \\ c ( x + j , y + i )\end{matrix} \vert \\ SAD 4 = {\sum }_{i = 0}^{15} {\sum }_{j = 0}^{15} \vert \begin{matrix}r ( {x}_{0} + j , {y}_{0} - 2 + i ) - \\ c ( x + j , y + i )\end{matrix} \vert \qquad [ Expression 2 ]$$

Next, in Step S102, the values of SAD0 to SAD4 are compared, and it is determined whether SAD0 is the smallest or not. When SAD0 is the smallest, a motion vector indicating the point (x₀, y₀) is regarded as a motion vector to be obtained in Step S001, and the routine of processing shown in FIG. 4 is terminated. When SAD0 is not the smallest, a point having an SAD which is the smallest of SAD0 to SAD4 is set as a new search center point in Step S103. That is:

$${x}_{0} = \{ \begin{matrix}{x}_{0} + 2 & if min ( SAD 1 , SAD 2 , SAD 3 , SAD 4 ) = SAD 1 \\ {x}_{0} - 2 & if min ( SAD 1 , SAD 2 , SAD 3 , SAD 4 ) = SAD 3 \\ {x}_{0} & otherwise\end{matrix} \\ {y}_{0} = \{ \begin{matrix}{y}_{0} + 2 & if min ( SAD 1 , SAD 2 , SAD 3 , SAD 4 ) = SAD 2 \\ {y}_{0} - 2 & if min ( SAD 1 , SAD 2 , SAD 3 , SAD 4 ) = SAD 4 \\ {y}_{0} & otherwise\end{matrix} \qquad [ Expression 3 ]$$

Since the SAD of the search center point set newly has been already calculated, new SAD0 can be obtained in Step S104 in accordance with the following expression.
SAD0=min(SAD1,SAD2,SAD3,SAD4) [Expression 4]

Further, the SAD of one of the new upper, lower, left and right search points with respect to the new search center point has been already obtained. Accordingly, the SAD which has been already searched is substituted in Step S105 in accordance with FIG. 5.

In Step S106, SADs regarded as “undefined” in Step S105 are calculated freshly based on Expressions 2. When the upper, lower, left and right SADs around the search center point set newly are obtained thus, the routine of processing returns to Step S102, in which it is determined again whether SAD0 is the smallest of SAD0 to SAD4 or not.

Processing from Step S103 to Step S106 is repeated till the result of determination in Step S102 is true. Thus, a region of the reference image the most similar to the macroblock of the image to be encoded is selected with two-pixel precision, and a motion vector corresponding thereto, that is, a rough-precision motion vector is obtained.

The process which has been described above is the process of Step S001. Set the motion vector obtained here as:

$$\begin{matrix}{MV}_{0} = ( {x}_{0} - x , {y}_{0} - y ) \\ = ( {X}_{0} , {Y}_{0} )\end{matrix} \qquad [ Expression 5 ]$$

At this time, SAD1, SAD2, SAD3 and SAD4 indicate similarities of search points two pixels distant from the search point (x₀, y₀) in the right, lower, left and upper directions respectively.

In Step S002, on which side a one-pixel precision motion vector is present on the left side or on the right side with respect to the current motion vector MV₀ is estimated from the obtained SADs of the peripheral search points. When a motion vector is obtained properly by the steepest-descent method, it can be estimated that SADs are expressed by a function in which values at search points adjacent to each other are continuous smoothly to each other. Accordingly, when SAD3 is much larger than SAD1, it is highly likely that the one-pixel precision motion vector to be obtained is on the right side of the current motion vector MV₀. On the contrary, when SAD3 is much smaller than SAD1, it is highly likely that the one-pixel precision motion vector to be obtained is on the left side of the current motion vector MV₀. Therefore, on the aforementioned assumption, a list showing a horizontal range of search points is decided in accordance with the following expression.

$$Xlist = \{ \begin{matrix}( 0 , 1 ) & SAD 1 - SAD 3 < T \\ ( - 1 , 0 ) & SAD 3 - SAD 1 < T \\ ( - 1 , 0 , 1 ) & otherwise\end{matrix} \qquad [ Expression 6 ]$$

Here, Xlist designates a list showing displacements of search points to be searched newly, with respect to the current motion vector. For example, (0, 1) designates that block matching is performed on a search point which is not displaced horizontally, and a search point which is displaced to right by one pixel. On the other hand, T designates a predetermined threshold value. Even when SADs are continuous smoothly, they do not always draw a symmetric curve near their minimum. It is therefore necessary to examine both the left and right sides of the current motion vector when there is not a large difference between SAD1 and SAD3.

In the same manner, when SAD4 is larger than SAD2, it is highly likely that the one-pixel precision motion vector to be obtained is on the lower side of the current motion vector MV₀. On the contrary, when SAD4 is smaller than SAD2, it is highly likely that the one-pixel precision motion vector to be obtained is on the upper side of the current motion vector MV₀. Therefore, in Step S003, a list Ylist in a vertical range of search points is decided in accordance with the following expression.

$$Ylist = \{ \begin{matrix}( 0 , 1 ) & SAD 2 - SAD 4 < T \\ ( - 1 , 0 ) & SAD 4 - SAD 2 < T \\ ( - 1 , 0 , 1 ) & otherwise\end{matrix} \qquad [ Expression 7 ]$$

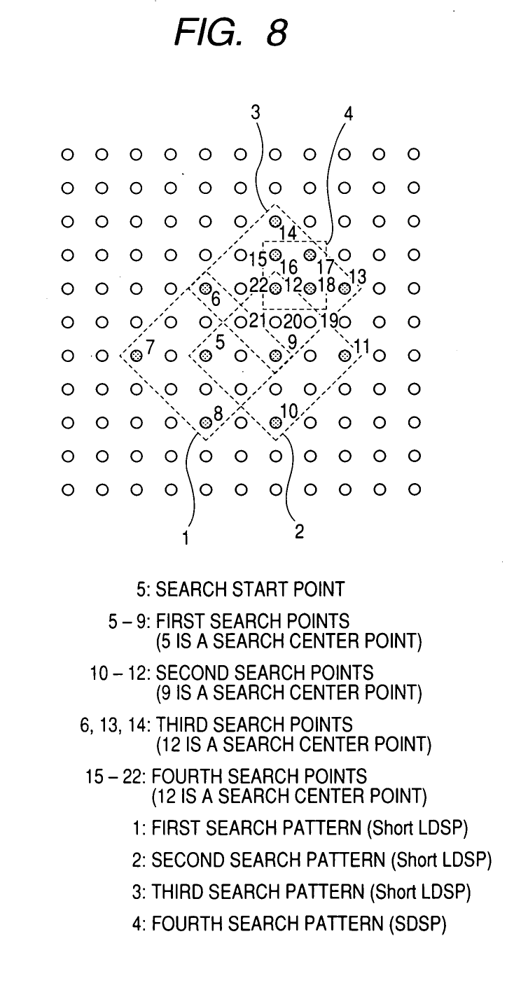

In Step S004, an SAD is obtained for, of all the combinations of search points obtained in Step S002 and Step S003, each search point whose SAD has not yet been obtained. FIG. 7 shows an example of a configuration in which this process is written in pseudo program code.

In FIG. 7, the SAD at the initial search point (x₀, y₀) is saved in SAD[0] (Step (a)). X-direction and Y-direction search ranges are decided in accordance with the size relationship among SAD values obtained at search points surrounding the initial search point (Step (b)). The initial search point (x₀, y₀) is a point indicated by a current rough-precision motion vector. Therefore, it is not necessary to calculate the SAD at the initial search point (x₀, y₀) newly. The other points are unsearched points. Therefore, SADs are obtained at those points respectively, and saved in an array SAD[j] (Step (c)). A total of N SADs (SAD[0] to SAD[N−1]) are obtained in such a procedure.

In Step S005, the SAD designated by the current motion vector obtained in Step S001 and the SADs obtained at all the search points in Step S004 are examined to obtain a smallest SAD. As described previously, the smallest SAD designates a region the most similar to the current macroblock. Accordingly, in Step S006, a search point corresponding to the obtained smallest SAD is regarded as a one-pixel precision motion vector. That is, an integer precision motion vector MVᵢₙₜ is defined in accordance with the following expression.
MVᵢₙₜ=(X₀+cx[m], Y₀+cy [m]) [Expression 8]
where m=arg min(SAD[0], . . . ,SAD[N−1])

Here, “arg min(x[0], . . . ,x[k−1])” designates a function of selecting a minimum value of the array from x[0] to x[k−1] and returning an index number thereof.

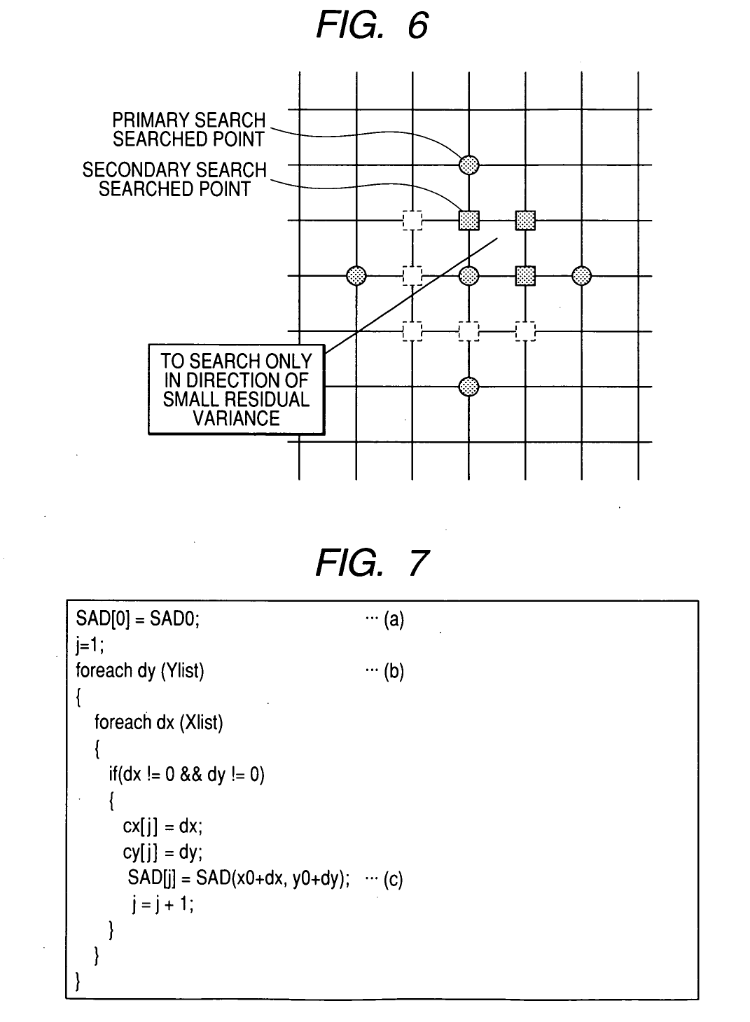

In the example of motion vector search disclosed in Non-Patent Document 2, eight search points surrounding a two-pixel precision motion vector have to be always searched regardless of the size relationship among the surrounding search points. Thus, the motion vector search process (block matching) becomes so massive that it takes much processing time. According to the invention, however, SADs of respective search points in the primary search are compared in terms of gradient or in-frame distribution, and new motion vector search points are restrictively set to be searched only in a direction in which the SAD is small. Thus, the number of search points for detecting the aforementioned one-pixel precision motion vector can be cut down to three points (see FIG. 6).

Here, assume that the gradient of similarities at search points, that is, the gradient of SADs means the degree of in-frame variation among the values of the SADs at the search points. New search points are set in a direction in which the values of SADs thereof will be smaller. In addition, assume that the in-frame distribution of similarities at search points, that is, the in-frame distribution of SADs means the in-frame existential state of the values of the SADs at the search points. Accordingly, the distribution of the values of the SADs at the search points in the primary search is examined, and new search points are set in a direction in which the values of SADs thereof will be smaller.

FIG. 8 shows a diagram in which the aforementioned example of a series of operations is expressed in the form of shifting of search points. First, assume that an initial search center point is located in a point 5. SADs are obtained for points 5, 6, 7, 8 and 9 located in the center and vertexes of a region of a search pattern 1 in accordance with Short LDSP.

Assume that an SAD corresponding to the point 9 is the smallest as a result. Next, SADs are obtained for unsearched points 10, 11 and 12 of vertexes of a Short LDSP search pattern 2 centering at the point 9. A point having the smallest SAD is selected from the points 10, 11 and 12 obtained thus and the points 5 and 9 obtained previously. Assume that the selected search point is the point 12. In a similar procedure, SADs are obtained for points 13 and 14, and a search point having the smallest SAD is selected from the points 6, 9, 12, 13 and 14.

Assume that the center point 12 of the search pattern is the search point having the smallest SAD as a result. Here, Step S001 corresponding to two-pixel precision motion vector search is terminated.

Next, the size of the SAD at the point 13 and that at the point 6 are compared with each other. Assume that the SAD at the point 13 is much smaller (Step S002). In the same manner, the size of the SAD at the point 9 and that at the point 14 are compared with each other. Assume that the SAD at the point 14 is much smaller (Step S003).

As a result, the points to be searched for the one-pixel precision motion vector are the points 16, 17 and 18. The search points shown in Non-Patent Document 2 are points 15, 19, 20, 21 and 22 as well as the points 16, 17 and 18. Thus, the number of search points can be cut down from eight points to three points. SADs are obtained for the three points to be searched (Step S004), and a point having the smallest SAD is selected from the points 12, 16, 17 and 18-(Step S005).

Assume that the point 17 is the point having the smallest SAD as a result. Then, a motion vector designating the point 17 is regarded as the one-pixel precision motion vector to be obtained (Step S006).

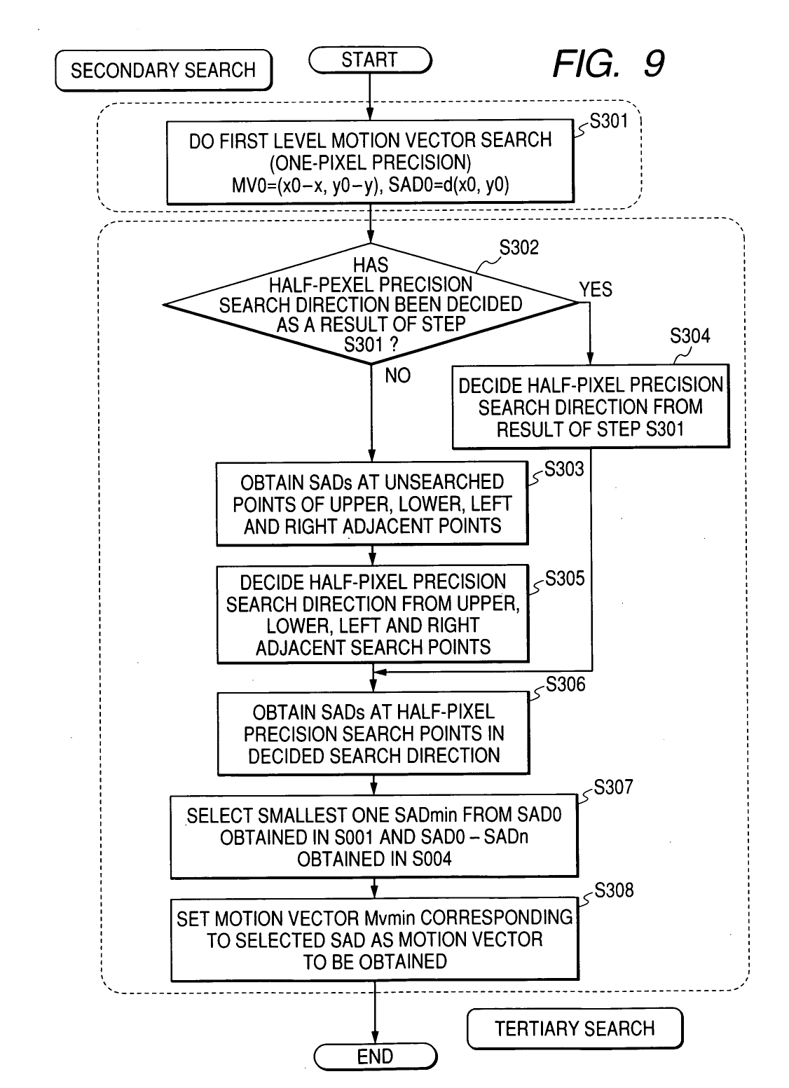

FIG. 9 is a flow chart showing a method for detecting a motion vector according to a second embodiment of the invention. This flow chart shows an example in which a half-pixel precision motion vector is obtained after a one-pixel precision motion vector is obtained as shown in the aforementioned first embodiment.

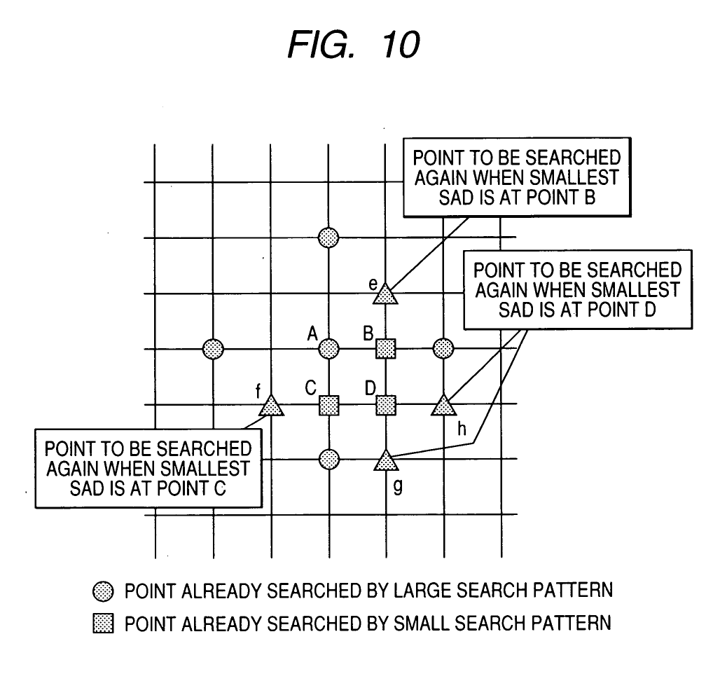

In Step S301, a one-pixel precision motion vector is obtained. Assume that the one-pixel precision motion vector is obtained by use of the method shown in the aforementioned first embodiment. In this case, of points located around a search point designated by the one-pixel precision motion vector, for example, points as shown in FIG. 10 have been already searched.

In Step S302, it is determined whether the direction to search a half-pixel precision motion vector has been already decidable or not. In order to specify the search direction in the same manner as in the aforementioned first embodiment, SADs at upper, lower, left and right adjacent search points are required. However, when the direction in which it is highly likely that the motion vector exists has been already specified in Step S301, the search direction can be decided without measuring the SADs.

In the example shown in FIG. 10, assume that a point A has been selected as the one-pixel precision motion vector as a result of Step S301. In this case, it is highly likely that the half-pixel precision motion vector exists at one of the right, lower and right lower points. Accordingly, in this case, it can be concluded that the search direction is decidable. In this event, processing of Step S304 is performed. However, when a point B, C or D has been selected as the one-pixel precision motion vector, the direction to search the half-pixel precision motion vector is not decidable. In this case, processing of Step S303 is performed.

In Step S303, an SAD is obtained for, of the upper, lower, left and right adjacent search points, each search point whose SAD has not yet been obtained. In the example of FIG. 10, an SAD is obtained for a point e when the one-pixel precision motion vector designates the point B, for a point f when the motion vector designates the point C, and for a point g and a point h when the motion vector designates the point D.

In Step S305, the direction to search the half-pixel precision motion vector is decided in the same manner as in Steps S002 and S003 in the first embodiment. That is, the direction to search the motion vector is decided on the basis of the size relationship among the SADs at the upper, lower, left and right adjacent search points.

On the other hand, in Step S304, the direction to search the half-pixel precision motion vector is decided on the basis of the result of Step S301 whose processing has been already performed.

In Step S306, an SAD is obtained for each half-pixel precision search point in the same manner as in Step S004 described previously. Further, in Step S307, a half-pixel precision motion vector is obtained in the same manner as in Step S005 described previously.

As described above, according to the invention, throughput can be saved in any of integer-pixel precision motion vector search and half-pixel precision motion vector search. Not to say, the method described here is also applicable, quite in the same manner, to another case that has not been described as an embodiment, for example, a case of quarter-pixel precision motion vector search.

As described above with reference to the embodiments, there is provided a motion vector detection method and apparatus hierarchically carries out a plurality of motion vector searches different in search precision. For example, a more detailed motion vector with one-pixel precision or half-pixel precision is searched based on a result of motion vector search obtained with rough precision such as two-pixel precision. In the motion vector detection method and apparatus, the number of search points can be cut down even in the subpixel precision motion vector search, so that the throughput for the motion vector search can be saved and the processing speed can be improved.

What is claimed is:

1. A motion vector detection method for detecting a motion vector indicating a displacement of a part of an image of a reference frame to an image of a partial region of a current frame, the method comprising:
obtaining similarities of images near a plurality of initial search points with the image of the partial region of the current frame, the initial search points being set on the reference frame;
setting a plurality of subsequent search point candidates based on either one of: (1) a gradient of the similarities obtained for the plurality of initial search points respectively; or (2) a distribution of the similarities obtained for the plurality of initial search points respectively;
obtaining similarities of images near the set plurality of search point candidates with the image of the partial region of the current frame; and
detecting a motion vector for the image of the partial region of the current frame based on a position of one of the plurality of search point candidates providing highest similarity of the similarities obtained for the plurality of search point candidates respectively.

2. The motion vector detection method according to claim 1, wherein the plurality of initial search points are set with two-pixel precision on the reference frame, and
wherein the plurality of search point candidates are set with precision of one pixel or less on the reference frame.

3. The motion vector detection method according to claim 1, wherein search point candidates near one of the plurality of initial search points having a large value one of the similarities obtained for the plurality of initial search points respectively are set by priority when setting the plurality of subsequent search point candidates.

4. The motion vector detection method according to claim 1, wherein when obtaining the similarities for the plurality of initial search points respectively, sums of absolute differences between the images near the plurality of initial search points and the image of the partial region of the current frame are obtained as evaluated scores of the similarities respectively.

5. The motion vector detection method according to claim 1, wherein search is repeated recursively based on a value of similarity between an image near a predetermined search center point and the image of the partial region of the current frame and values of similarities between images near search point candidates surrounding the predetermined search center point and the image of the partial region of the current frame, and of a plurality of initial search point candidates, ones each having a large value of similarity are decided as the plurality of initial search points.

6. The motion vector detection method according to claim 1, wherein the similarities for the plurality of initial search points are obtained by calculating the similarities for search points that are a part of search point candidates in a predetermined search range.

7. The motion vector detection method according to claim 1, wherein when setting the plurality of subsequent search point candidates, values of similarities are compared for, of the plurality of initial search points, a plurality of initial search points aligned with each other in one of a vertical direction and a horizontal direction, and the plurality of subsequent search point candidates are set in the vertical direction or the horizontal direction on the reference frame to increase the values of similarities.

8. The motion vector detection method according to claim 1, wherein when setting the plurality of subsequent search point candidates, values of similarities are compared for, of the plurality of initial search points, a plurality of initial search points adjacent to each other in one of a vertical direction and a horizontal direction, and when a difference between the values of similarities is zero or not larger than a predetermined threshold value, the plurality of subsequent search point candidates are set to include candidates between the plurality of initial search points adjacent to each other.

9. A motion vector detection apparatus that detects a motion vector indicating a displacement of a part of an image of a reference frame to an image of a partial region of a current frame, the motion vector detection apparatus comprising:
a first obtaining unit that obtains similarities of images near a plurality of initial search points with the image of the partial region of the current frame, the initial search points being set on the reference frame;
a setting unit that sets a plurality of subsequent search point candidates based on either one of: (1) a gradient of the similarities obtained for the plurality of initial search points respectively; or (2) a distribution of the similarities obtained for the plurality of initial search points respectively;
a second obtaining unit that obtains similarities of images near the set plurality of search point candidates with the image of the partial region of the current frame; and
a detecting unit that detects a motion vector for the image of the partial region of the current frame based on a position of one of the plurality of search point candidates providing highest similarity of the similarities obtained for the plurality of search point candidates respectively.

10. The motion vector detection apparatus according to claim 9, wherein the plurality of initial search points are set with two-pixel precision on the reference frame, and
wherein the plurality of search point candidates are set with precision of one pixel or less on the reference frame.

11. The motion vector detection apparatus according to claim 9, wherein the setting unit sets by priority search point candidates near one of the plurality of initial search points having a large value one of the similarities obtained for the plurality of initial search points respectively when setting the plurality of subsequent search point candidates.

12. The motion vector detection apparatus according to claim 9, wherein when obtaining the similarities for the plurality of initial search points respectively, the setting unit obtains sums of absolute differences between the images near the plurality of initial search points and the image of the partial region of the current frame as evaluated scores of the similarities respectively.

13. The motion vector detection apparatus according to claim 9, wherein search is repeated recursively based on a value of similarity between an image near a predetermined search center point and the image of the partial region of the current frame and values of similarities between images near search point candidates surrounding the predetermined search center point and the image of the partial region of the current frame, and of a plurality of initial search point candidates, ones each having a large value of similarity are decided as the plurality of initial search points.

14. The motion vector detection apparatus according to claim 9, wherein the first obtaining unit obtains the similarities for the plurality of initial search points by calculating the similarities for search points that are a part of search point candidates in a predetermined search range.

15. The motion vector detection apparatus according to claim 9, wherein when setting the plurality of subsequent search point candidates, the setting unit sets values of similarities are compared for, of the plurality of initial search points, a plurality of initial search points adjacent to each other in one of a vertical direction and a horizontal direction, and the plurality of subsequent search point candidates in the vertical direction or the horizontal direction on the reference frame to increase the values of similarities.

16. The motion vector detection apparatus according to claim 9, wherein when setting the plurality of subsequent search point candidates, the second obtaining unit compares values of similarities for, of the plurality of initial search points, a plurality of initial search points adjacent to each other in one of a vertical direction and a horizontal direction, and
wherein when a difference between the values of similarities is zero or not larger than a predetermined threshold value, the second obtaining unit sets the plurality of subsequent search point candidates to include candidates between the plurality of initial search points adjacent to each other.

17. A computer-readable program product for causing a computer system to execute procedures for detecting a motion vector indicating a displacement of a part of an image of a reference frame to an image of a partial region of a current frame, the procedures comprising:
obtaining similarities of images near a plurality of initial search points with the image of the partial region of the current frame, the initial search points being set on the reference frame;
setting a plurality of subsequent search point candidates based on either one of: (1) a gradient of the similarities obtained for the plurality of initial search points respectively; or (2) a distribution of the similarities obtained for the plurality of initial search points respectively;
obtaining similarities of images near the set plurality of search point candidates with the image of the partial region of the current frame; and
detecting a motion vector for the image of the partial region of the current frame based on a position of one of the plurality of search point candidates providing highest similarity of the similarities obtained for the plurality of search point candidates respectively.
